(19) United States
(12) Patent Application Publication
(10) Pub. No.: US 2005/0098693 A1
(43) Pub. Date: May 12, 2005

(54) Leveling system

(76) Inventors: Daniel Holt, Kettle Falls, WA (US); Monte Weaver, Colville, WA (US); Gordon E. Taylor, Laurier, WA (US)

Correspondence Address: MERCHANT & GOULD PC, P.O. BOX 2903, MINNEAPOLIS, MN, 55402-0903, US

(21) Appl. No.: 10/705,607

(22) Filed: Nov. 10, 2003

(51) Int. Cl. F16M 11/24

(52) U.S. Cl. 248/188.2; 248/188.4; 248/188.8

(57) ABSTRACT

The invention generally relates to an appliance leveling system that includes a bolt having a threaded portion and a diameter, a nut, and a threaded aperture configured to engage the threaded portion of the bolt, and an appliance leg including a first bolt receiving aperture and a nut receiving structure. The diameter of the first bolt receiving aperture is greater than the bolt diameter to provide free axial movement of the bolt relative to the first bolt receiving aperture. The nut receiving structure is configured to receive and retain the nut so that rotation of the bolt relative to the nut adjusts a vertical height of the appliance.

### BACKGROUND OF THE INVENTION

1. Field of the Invention

The present invention relates to a leveling system. More particularly, the invention relates to a leveling system for appliances.

2. Related Art

Appliances in general, and especially stoves or other fuel-burning devices, need to be level for proper and safe operation. Factory-built fireplace and stove assemblies have long been available as both freestanding and wall recessed units. During the installation, fireplace assemblies are generally leveled as needed. With freestanding units this leveling is usually done by adjusting a threaded screw either up or down. For example, the legs of a freestanding appliance unit would have threaded holes in the bottom. A screw attached to a base would be inserted into each of the holes in the legs of the appliance until the unit is level.

A disadvantage of present leveling systems is that it can be particularly difficult to adjust the threaded screws to adjust the height of the appliance. In particular, appliances, such as cast iron and steel wood stoves, are quite heavy and in order to adjust the threaded screw, the weight of the applicant must be lifted off of the leg that is to be adjusted in height. Lifting and maneuvering a large appliance to effect the required amount of leveling can be difficult and unsafe.

Another disadvantage to traditional leveling systems is that the holes usually need to be machined separately from the manufacturing of the appliance base or leg. For example, in a typical leveling system, the leg is first cast or molded and then only after the leg is preformed, can the threaded holes be created in the base of the leg. Therefore, it would be preferable to develop a leveling system that does not require this two-step manufacturing process.

Yet another disadvantage to a traditional leveling system is that the threaded holes are often also used to aid in the transport of the appliance. For example, the appliance is often screwed through a pallet and machined threads formed in the leg to facilitate the transportation of the appliance from its place of manufacture to its point of use. Because of the stresses involved in transporting a large appliance on a pallet, the machined threads in the leg of the appliance often get stripped out, thereby diminishing or eliminating their effectiveness as a leveling tool. Alternatively, the threaded screws can break and within the threaded holes and it can be difficult to remove the broken screws or bolts from the unit.

Accordingly, it is desirable to provide an appliance system, including fuel-burning stove systems, with an improved way to transport and level the appliance during installation.

### SUMMARY OF THE INVENTION

The present invention generally relates to a leveling system and more particularly relates to a system for leveling an appliance. The leveling system provides an adjustment mechanism that controls the height of an appliance and facilitates handling of the appliance during shipping. The leveling system is supported by a leg of the appliance in a way that minimizes damage to the appliance.

One aspect of the invention relates to an appliance leveling system that includes a bolt having a threaded portion with a diameter, a nut having a threaded aperture configured to engage the threaded portion of the bolt, and an appliance leg including a first bolt receiving aperture and a nut receiving structure. The diameter of the first bolt receiving aperture is greater than the bolt diameter to provide free axial movement of the bolt relative to the first bolt receiving aperture. The nut receiving structure is configured to receive and retain the nut so that rotation of the bolt relative to the nut adjusts a vertical height of the appliance.

Another aspect of the invention relates to an appliance that includes a leg having an aperture formed in an end of the leg, and a leveling system configured to level the appliance. The leveling system includes a threaded bolt, a nut having a threaded aperture sized to engage the threaded bolt, and a nut receiving structure sized to receive and retain the nut in a position in which the threaded aperture is aligned with the leg aperture. The leg aperture is sized to facilitate free axial movement of the threaded bolt through the leg aperture without engaging the threads of the bolt, and rotation of the threaded bolt relative to the nut adjusts a vertical height of the appliance.

A further aspect of the invention relates to a method of adjusting the vertical position of an appliance. The appliance includes a threaded bolt, a nut having a threaded aperture sized to engage the threaded bolt, and a leg having a nut receiving structure and a bolt receiving aperture formed in an end of the leg. The method includes the steps of positioning the nut in the nut receiving structure thereby retaining the nut, threading the bolt into the threaded aperture of the nut, and moving the bolt through the bolt receiving aperture without engaging the threads of the bolt. Rotating the bolt relative to the retained nut adjust the height of the appliance.

The above summary of the present invention is not intended to describe each disclosed embodiment or every implementation of the present invention. Figures in the detailed description that follow more particularly exemplify embodiments of the invention. While certain embodiments will be illustrated and describing embodiments of the invention, the invention is not limited to use in such embodiments.

### BRIEF DESCRIPTION OF THE DRAWINGS

The invention may be more completely understood in consideration of the following detailed description of various embodiments of the invention in connection with the accompanying drawings, in which:

FIG. 1 is an exploded perspective view of an example leveling system and appliance leg in accordance with principles of the present invention;

FIG. 2 is an exploded perspective view of the leveling system shown in FIG. 1 with the nut and bolt engaged together;

FIG. 3 is an exploded perspective view of the leveling system shown in FIG. 1 with the nut and bolt positioned in the appliance leg;

FIG. 4 is an exploded perspective view of the leveling system shown in FIG. 1 with the nut and bolt positioned in the appliance leg and the bolt extending through an aperture in the end of the appliance leg;

FIG. 5 is a perspective view of an example appliance incorporating the leveling system shown in FIGS. 1-4; and

FIG. 6 is a perspective view of another example appliance leg configuration suited for use with the leveling system shown in FIG. 1.

While the invention is amenable to various modifications and alternate forms, specifics thereof have been shown by way of example and the drawings, and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE PREFERRED EMBODIMENTS

The present invention generally relates to a leveling system and more particularly relates to a system for leveling an appliance. The leveling system provides an adjustment mechanism that controls the height of an appliance and facilitates handling of the appliance during shipping. The leveling system is supported by and cooperates with a leg of the appliance in a way that minimizes damage to the appliance. While the present invention is not so limited, an appreciation of the various aspects of the invention will be gained through a discussion of the examples provided below.

Embodiments of the present invention may be used in conjunction with any system or apparatus that requires leveling and which can be modified to use the leveling system described herein. A non-exhaustive list of such devices may include stoves, refrigerators, washers, dryers, and other appliances. While the example embodiments of the present invention provided below are described in conjunction with an example fuel-burning stove (generally referred to as an appliance unit), the present invention is equally applicable to other systems or apparatuses. It is contemplated that the present invention is preferably used with a freestanding appliance. However, certain appliances that are insets or are supported by other structures may benefit from the invention if the appliance requires leveling. Moreover, although it is contemplated that most uses of the invention will be with a system that has four legs (e.g., a four leg stove), it is also contemplated that the present invention may be suited for use with an appliance or other structure that has at least one leg and required vertical adjustment of the appliance or structure.

As used herein, the term “coupled” is defined as any structure or method that may be used to provide connectivity between two or more elements, which may or may not include a direct physical connection between the elements. The term “engage” or “engaging” is defined as actual physical contact between two or more elements. The term “receive” means to come into possession of or to access, but does not require actual physical contact. The term “retain” means to hold or possess, but not does require holding in a single, immovable position and orientation.

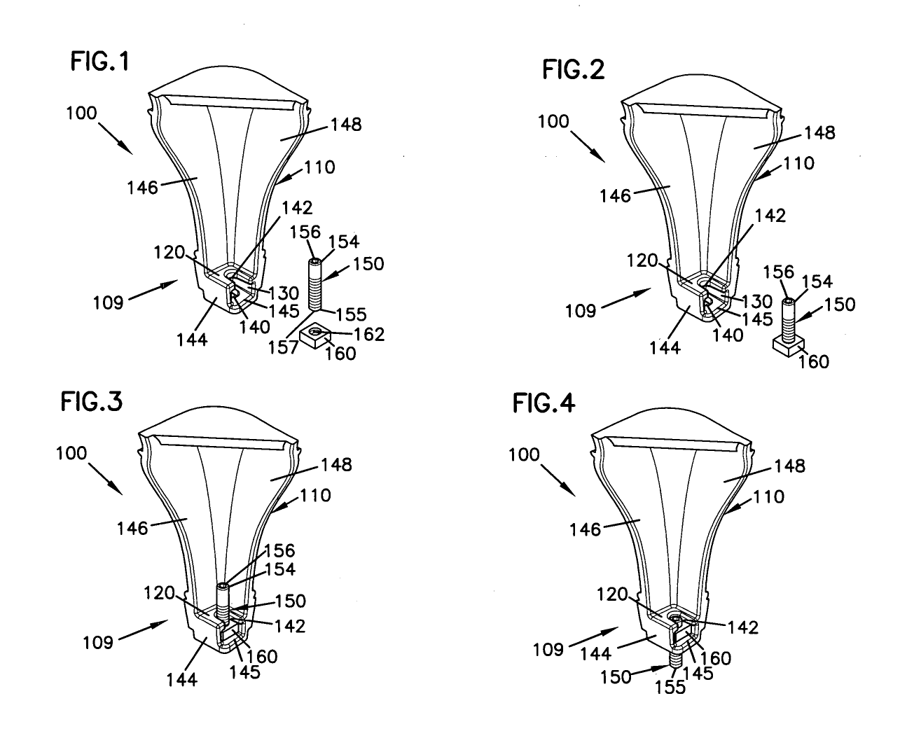

Referring now to FIG. 1, a perspective view of an example embodiment of a leveling system 100 is shown. Leveling system 100 is shown in this example in association with a base or end 109 of an appliance leg 110. The leg 110 generally functions to support an appliance unit (for example, see appliance 170 in FIG. 5) or other appliance that requires leveling. Typically, a free standing appliance unit will have at least three legs 110 to provide proper support.

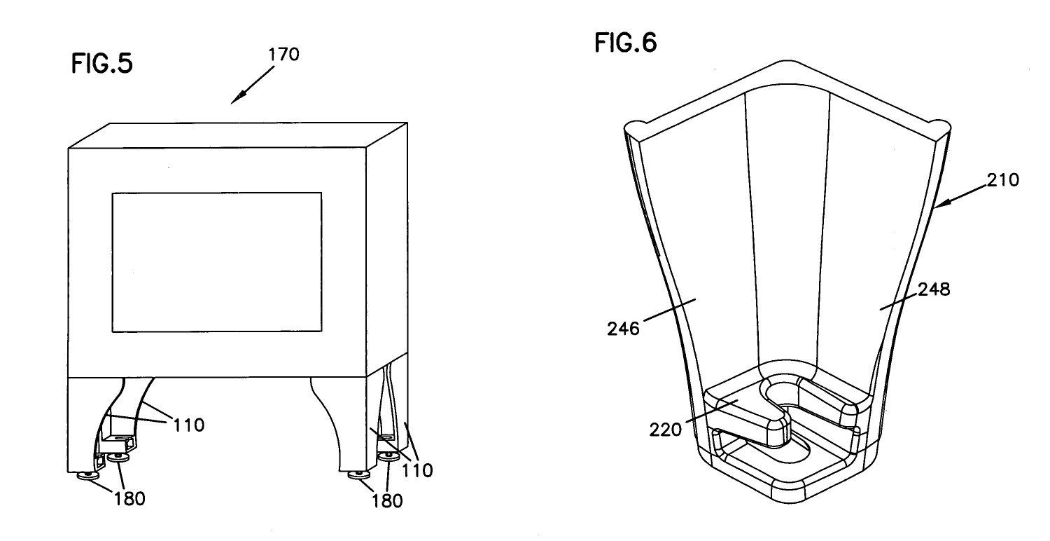

As shown in FIG. 1, leg 110 includes a cross member 120, a nut receiving area 130, a first bolt receiving aperture 140 formed in a bottom member 145, and a second bolt receiving aperture 142 formed in cross member 120. Leveling system 100 includes a bolt 150 and a nut 160 that cooperate with features of leg 110 to adjust a vertical position of leg 110. Cross member 120 extends in a generally horizontal plane between sidewalls 144, 146, 148 of appliance leg 110 and the second bolt receiving aperture 142 extends through cross member 120 in a direction aligned with an axis of the first bolt receiving aperture 140. In other embodiments, cross member 120 may extend from only one side wall of the appliance leg 110, or may be a cross member 220 that extends from two side walls 246, 248 of an appliance leg 210, as shown in FIG. 6. Second bolt receiving aperture 142 may be a cylindrical hole or may be a slot formed in cross member 120, as shown in FIGS. 1-4.

Leg 110 may be manufactured in any number ways and of any number of materials. Leg 110 is preferably formed as one integral piece, for example, by casting using metal, or by molding using polymer materials or inorganic fibers and a binder. It is not necessary, however, that leg 110 be formed in one-piece. The method of manufacturing leg 110 and the materials selected for leg 110 will depend on the particular requirements of the appliance that is to be supported by leg 110.

Referring now to FIGS. 2-4, the features of the leveling system 100 will be described in more detail. Bolt 150 is inserted into a threaded aperture 162 of nut 160. Bolt 150 preferably includes an adjustment structure 154 that facilitates engagement of bolt 150 for handling and rotation of bolt 150. Adjustment structure 154 is preferable positioned at a first end 156 of bolt 150 and may include a bolt head structure (such as a hex head, not shown) or a recesses area configured to accept an Allen type wrench as shown in FIGS. 1-4. A recesses Allen type structure may be useful for rotating bolt 150 when bolt 150 is positioned within the leveling system at a location where bolt 150 is only accessible from above or from a small area on a side of bolt 150 (see FIG. 4). In other embodiments, a removable covering may be placed over the area of accessibility of adjustment structure 154 for aesthetics purposes. For example, access to adjustment portion 154 could be hidden by a leg covering that conceals the inside of leg 110 (the back side of leg 110 as shown in FIG. 5).

Bolt adjustment structure 154 may be adjusted by providing a rotational torque force to the adjustment portion. In this manner, the applied torque force causes a threaded portion 155 of the bolt 150 to engage threaded aperture 162 of nut 160 and eventually extend through leg aperture 140 formed in bottom member 145. Bottom member 145 is also configured to restrict movement of nut 160 in a downward direction. In FIGS. 1-4, bottom member 145 is shown integral to the leg 110 to level the appliance. In other embodiments, bottom member 145 is a separate piece that is secured to leg 110. Leg aperture 140 has a diameter that is larger than a diameter of bolt 150 to ensure that bolt 150 may pass freely through leg aperture 140 (a “pass through” aperture). Leg aperture 140 preferably has smooth sidewalls without threads.

The threaded portion 155 of bolt 150 extends along at least that portion of the length of bolt 155 that is intended to pass through threaded aperture 162 of nut 160. If desired, the range of vertical adjustment possible with leveling system 100 may be controlled by the length of threaded portion 155. For example, a certain threaded portion length may be used to restrict the user of the leveling system from over extending the bolt 150 through nut 160, which over extension would cause the leveling system to be unable to support the weight of the appliance, or to otherwise fail.

Referring now to FIG. 3, nut 160, with bolt 150 attached, is inserted into nut receiving area 130. Bolt 150 extends through second bolt receiving aperture 142. The second aperture 142 is an open slot in this embodiment, but may be a cylindrical aperture or the like closed aperture in other embodiment that requires bolt 150 to be threaded into nut 160 after nut 160 is positioned in nut receiving area 130. At a minimum, second aperture 142 must be sized to retain nut 160 within nut receiving area 130.

Nut receiving area 130 is substantially rectangular in shape so as to match the outer shape of nut 160. The shape of nut receiving area 130 serves to hold nut 160 in place while bolt 150 is adjusted. Although the shape of nut receiving area 130 is shown to be rectangular, other shapes may be used so long as they function to retain nut 160 within leg 110, limit axial movement of nut 160, and restrict rotational movement of nut 160 about an axis of first aperture 140 within a certain range of rotation, for example, less than about 45° to 90° of rotation.

Traditional leveling methods require height adjustment of the appliance leg using a threaded bolt or other adjustment mechanism engaged in a threaded aperture at the bottom of the leg. Such a leveling system is typically adjusted by lifting the appliance leg and screwing the adjustment mechanism into or out of the threaded aperture in the bottom of the appliance leg. With the present leveling system, the height of the leg can be adjusted without raising the appliance leg off the ground. Instead, a torque force is applied to rotate bolt 150 relative to nut 160 and the leg is raised or lowered without access to the bottom of leg 110 or otherwise relieve the weight of the appliance from the bottom of leg 110. This arrangement allows for the height of leg 110 to be adjusted by turning bolt 150. Therefore, unlike the traditional ways of leveling appliances, the present invention eliminates the need to first lift the appliance unit before adjusting the height of leg 110.

Another benefit of the present leveling system is that the leveling system can be manufactured with fewer or at least typically less costly manufacturing steps. The present leveling system eliminates the need for the leg of the appliance to be threaded by a separate manufacturing step. In this way, leg 110 can be manufactured in one casting or molding step, without the need for a separate machining step. The bolts and nuts described in the present invention can be purchased from any suitable manufacturer and they need not be specially manufactured for the present invention, which further reduces costs. In addition, the machine error that is introduced by a separate machining step is also eliminated, so that the likelihood of malfunctioning of the leveling system is likewise reduced.

Referring now to FIG. 5, an example appliance 170 that uses the leveling system described above with reference to FIGS. 1-4 is shown. Each leg 110 of appliance 170 shown in FIG. 5 utilizes the leveling system described above. However, it is not necessary that each leg be equipped with the leveling system, nor is it necessary that an appliance have four legs as shown in FIG. 5.

In some embodiments, a footing 180 may be secured to threaded portion 155 of bolt 150. Footing 180 protects the floor or ground surface from any damage that may occur when adjusting bolt 150 to level the appliance. Footing 180 may be a cap that is slipped over bolt 150, screwed into threaded portion 155 of bolt 150, or coupled by some other mechanical means.

In addition, the present invention also provides a desirable system for connecting the appliance unit to a pallet for transportation. For example, an appliance unit can be placed on top of a pallet and the pallet may be coupled to legs of the appliance unit by a coupling bolt, such as bolt 150. Alternatively, the coupling bolt may be longer or shorter than bolt 150 depending on the exact length that is needed to extend through the thickness of the pallet being used. The coupling bolt is preferably long enough to extend through a hole in the pallet and through hole 140 in leg 110 and nut 160. By this arrangement, the appliance unit can be securely coupled to the pallet.

Moreover, since leg 110 is coupled to the pallet through a coupling bolt such as bolt 150, the only threads that can be damaged during transport of the appliance unit are the threads of nut 160 and bolt 150. Since nut 160 and bolt 150 are typically inexpensive parts, these damaged parts can be easily and cheaply replaced to provide a functioning the leveling system after the appliance unit is transported. Thus, the appliance unit is not adversely affected during the transporting of the appliance unit and the potential damage that occurs to the leveling system can be easily remedied.

The present invention should not be considered limited to the particular examples or materials described above, but rather should be understood to cover all aspect of the invention as fairly set out in the attached claims. Various modifications, equivalent processes, as well as numerous structures to which the present invention may be applicable will be readily apparent to those of skill in the art to which the present invention is directed upon review of the instant specification.

1. An appliance leveling system, comprising:
a bolt having a threaded portion with a diameter;
a nut having a threaded aperture configured to engage the treaded portion of the bolt; and
an appliance leg including a first generally horizontally oriented member, a second generally horizontally oriented member positioned at a vertically spaced apart location from the first horizontally oriented member, at least two vertically oriented side walls extending between the first and second horizontally oriented members, a first bolt receiving aperture formed in the first horizontally oriented member and having a diameter greater than the bolt diameter, a second bolt receiving aperture formed in the second horizontally oriented member and having a diameter greater than the bolt diameter, and a nut receiving structure defined by the first and second horizontally oriented members and the at least two vertically oriented side walls, the nut receiving structure configured to receive and retain the nut;
whereby rotation of the bolt relative to the nut adjusts a vertical height of the appliance.

2. The system of claim 1, wherein the first horizontally oriented member defines a vertically lower most surface of the appliance leg.

3. The system of claim 1, wherein the nut receiving structure defines a slot that is open in a direction perpendicular to an axis of the threaded aperture for insertion of the nut into the slot.

4. The system of claim 1, wherein the the first and second bolt receiving apertures are sized to provide free axial movement of the bolt relative to firs and second horizontally oriented members.

5. The system of claim 1, wherein the nut is removably positioned in the nut receiving structure.

6. The system of claim 1, wherein the bolt further includes an adjustment structure that facilitates rotation of the bolt, the adjustment structure being exposed at an end of the bolt positioned vertically above the first horizontally oriented member.

7. The system of claim 1, wherein the nut receiving structure is integrally formed as a single piece.

8. The system of claim 1, wherein the nut has a square shaped circumference and the nut receiving structure includes a generally square shaped recess having an internal size substantially the same size as the outer circumference of the nut.

9. An appliance, comprising:
a leveling system including a threaded bolt and a nut having a threaded aperture sized to engage the threaded bolt; and
a leg having an end member defining a lower most surface of the appliance, a first aperture formed in the end member, a cross member extending in an orientation generally parallel to the end member and positioned vertically space above the end member, the cross member including a second aperture aligned with the first aperture, and a nut receiving structure defined by the end member, the cross member, and a plurality of side members extending between the end and cross members, the nut receiving structure being sized to receive and retain the nut in a position in which the threaded aperture is aligned with the leg aperture, the nut receiving structure being integrally formed as a single piece;
wherein the is first and second apertures are sized to facilitate free axial movement of the threaded bolt, and rotation of the threaded bolt relative to the nut adjusts a vertical height of the appliance.

10. The appliance of claim 9, wherein the appliance is a heat generating device.

11. The appliance of claim 9, wherein the heat generating device is a fuel burning stove, the stove including a plurality of panels that define an enclosed combustion chamber enclosure wherein fuel is burned for the generation of heat.

12. The appliance of claim 9, wherein the appliance includes at least two legs, each leg including the leveling system, the leg aperture, and the nut receiving structure.

13. The appliance of claim 9, wherein the nut has a square shaped circumference.

14. The appliance of claim 9, wherein the the first and second apertures have a diameter that is greater than a diameter of the threaded bolt.

15. The appliance of claim 9, wherein the end and cross members extend in a direction perpendicular to an axis of the first and second apertures aperture, the cavity having a size substantially similar to die size of the nut.

16. The appliance of claim 15, wherein the cavity is open on at least one side of the leg to removably position the nut in the nut receiving structure.

17. The appliance of claim 15, wherein the cavity size limits rotation of the nut about an axis of the threaded aperture less than 45 degrees.

18. A method of adjusting a height of an appliance, the appliance including a threaded bolt, a nut having an threaded aperture sized to engage the threaded bolt, and a leg having an end member, a cross member and a plurality of sidewalls that together define a nut receiving structure within the leg, the end member including a fist bolt receiving aperture and the cross member including a second bolt receiving aperture aligned with the first bolt receiving structure, the method comprising the steps of:
positioning the nut in the nut receiving structure thereby retaining the nut and restricting rotation of the nut relative to the leg;
threading the bolt into the threaded aperture of the nut; and
moving the bolt through the first and second bolt receiving apertures without engaging the leg;
whereby rotation of the bolt relative to the retained nut adjusts the height of the appliance.

19. The method of claim 18, wherein the nut receiving structure includes a slot having an internal shape and size that substantially matches an outer shape and size of the nut, and the positioning step includes moving the nut into the slot.

20. The method of claim 18, wherein the threaded bolt includes an adjustment structure positioned at an end of the bolt positioned vertically above the end member, and the threading step including engaging the adjustment structure to rotate the threaded bolt relative to the nut.

21. The method of claim 20, wherein the adjustment structure includes an Allen type structure having at least five sidewalls, and the threading step includes engaging the Allen structure with an Allen wrench and rotating the threaded bolt with the Allen wrench.

22. The method of claim 18, wherein the nut receiving structure is formed as a single, unitary piece.
